(19) United States
(12) Patent Application Publication
(10) Pub. No.: US 2026/0269402 A1
(43) Pub. Date: Sep. 10, 2026

(54) BATTERY PACK

(71) Applicant: TOYOTA JIDOSHA KABUSHIKI KAISHA, Toyota-shi (JP)

(72) Inventor: Tsuguhiro KOZUKA, Kariya-shi (JP)

(73) Assignee: TOYOTA JIDOSHA KABUSHIKI KAISHA, Toyota-shi (JP)

(21) Appl. No.: 19/444,899

(22) Filed: Jan. 9, 2026

(30) Foreign Application Priority Data
Mar. 5, 2025 (JP) 2025-034418

(51) Int. Cl. H01M 50/242; H01M 50/204; H01M 50/224; H01M 50/249; B60K 1/04

(52) U.S. Cl. CPC H01M 50/242; H01M 50/204; H01M 50/224; H01M 50/249; B60K 1/04; H01M 2220/20

(57) ABSTRACT

A battery pack includes: a battery case that houses a battery module including a plurality of battery cells and is mounted on a vehicle; and a panel member that is provided immediately below the battery case and is exposed to an outside of the vehicle. A cross section of the panel member cut along a plane orthogonal to a horizontal direction has a shape with a plurality of holes. A size of each of the holes gradually decreases from a bottom to a top.

### CROSS-REFERENCE TO RELATED APPLICATION

This application claims priority to Japanese Patent Application No. 2025-034418 filed on Mar. 5, 2025. The disclosure of the above-identified application, including the specification, drawings, and claims, is incorporated by reference herein in its entirety.

### BACKGROUND

### Technical Field

The present disclosure relates to a battery pack.

### Description of Related Art

Japanese Unexamined Patent Application Publication No. 2023-503506 (JP 2023-503506 A) discloses a battery pack in which a battery module (battery array) is housed in a battery case.

### SUMMARY

The battery pack of JP 2023-503506 A has room for improvement in terms of achieving both heat resistance and shock resistance against a colliding object.

In view of the above fact, an object of the present disclosure is to provide a battery pack in which a panel member provided immediately below a battery case can exhibit high heat resistance and high shock resistance against a colliding object.

A battery pack according to a first aspect includes: a battery case that houses a battery module including a plurality of battery cells and is mounted on a vehicle; and a panel member that is provided immediately below the battery case and is exposed to an outside of the vehicle. A cross section of the panel member cut along a plane orthogonal to a horizontal direction has a shape with a plurality of holes. A size of each of the holes gradually decreases from a bottom to a top.

In the battery pack according to the first aspect, the panel member is provided immediately below the battery case, and the cross section of the panel member cut along the plane orthogonal to the horizontal direction has the shape with the holes. The size of each of the holes gradually decreases from the bottom to the top.

Therefore, the upper portion of the panel member has higher heat resistance than the lower portion. Thus, even if the temperature in the region around the battery case increases, the upper portion of the panel member can suppress transfer of the heat to the battery case.

When an object collides with the panel member, the lower portion of the panel member can exhibit higher shock resistance than the upper portion. Therefore, when an object (colliding object) collides with the lower surface of the panel member, the lower portion of the panel flexibly deforms and can absorb the shock.

The panel member provided immediately below the battery case of the battery pack according to the first aspect can exhibit high heat resistance and high shock resistance against a colliding object.

In a battery pack according to a second aspect, in the first aspect, the holes are hexagonal holes.

In the battery pack according to the second aspect, each hole in the panel member is hexagonal. That is, the internal structure of the panel member is a honeycomb structure. Therefore, the panel member can exhibit greater shock absorption properties than in the case where the holes have a shape other than the hexagonal shape.

In a battery pack according to a third aspect, in the first or second aspect, the panel member is made of iron.

In the battery pack according to the third aspect, the panel member is made of iron. Therefore, the panel member has higher heat resistance than in the case where the panel member is made of aluminum.

As described above, the battery pack according to the present disclosure has the excellent effect that the panel member provided immediately below the battery case can exhibit high heat resistance and high shock resistance against a colliding object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view taken at the center in a vehicle width direction of a vehicle including a battery pack according to an embodiment;

FIG. 2 is a schematic exploded perspective view of the battery pack; and

FIG. 3 is a schematic sectional view of a panel member.

### DETAILED DESCRIPTION OF EMBODIMENTS

A battery pack according to an embodiment will be described below with reference to the accompanying drawings. Arrows UP, FR, and LH in each drawing indicate an upper side in an up-down direction of a vehicle, a front side in a front-rear direction of the vehicle, and a left side in a right-left direction of the vehicle, respectively.

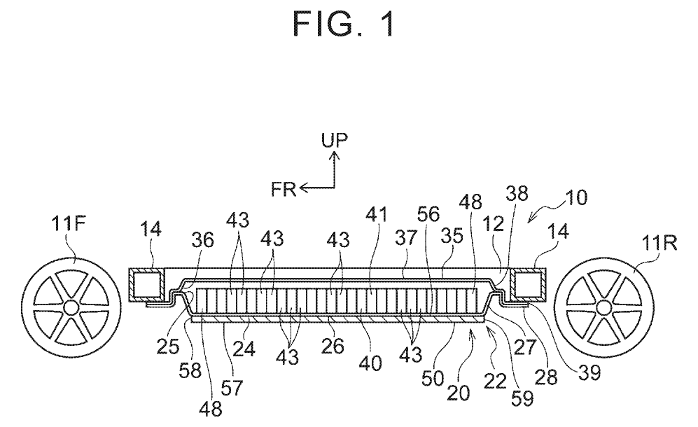

As shown in FIG. 1, a battery pack 20 according to the present embodiment is mounted on a vehicle (electrified vehicle) 10. The vehicle 10 according to the present embodiment is a battery electric vehicle.

The vehicle 10 includes a pair of right and left front wheels 11F, a pair of right and left rear wheels 11R, a pair of right and left rockers 12 that is part of a body frame member and extends in the front-rear direction of the vehicle, and a pair of front and rear cross members 14 that is part of the body frame member and extends in the width direction of the vehicle (right-left direction) with both ends fixed to the right and left rockers 12.

The battery pack 20 according to the present embodiment includes a battery case 22, a battery module 40, and a panel member 50. Electric power of the battery pack 20 (battery cells 43) is supplied to an electric motor (not shown) that applies a driving force to driving wheels that are, for example, at least either of the front wheels 11F and the rear wheels 11R.

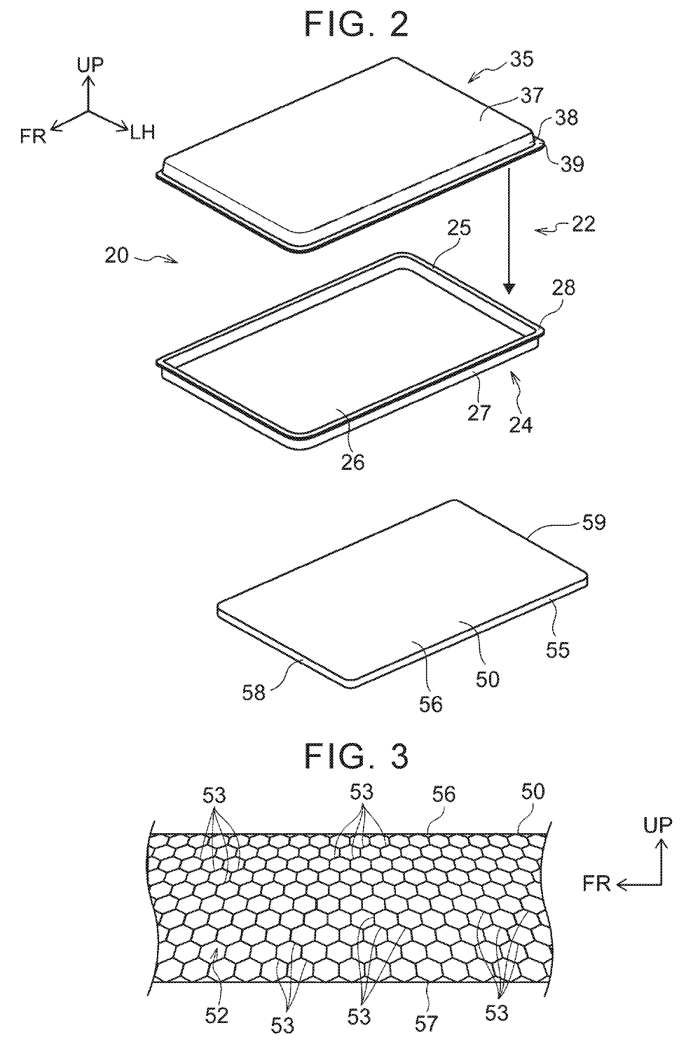

As shown in FIGS. 1 and 2, the battery case 22 includes a lower case 24 and an upper case 35.

The lower case 24 is a hollow body having an opening 25 formed at the top. The lower case 24 includes a bottom plate portion 26, a peripheral wall portion 27, and an outer peripheral flange 28. The peripheral wall portion 27 has a looped planar shape, and the lower end of the peripheral wall portion 27 is connected to the outer peripheral edge of the bottom plate portion 26. The outer peripheral flange 28 has a looped planar shape, and the inner peripheral edge of the outer peripheral flange 28 is connected to the upper end of the peripheral wall portion 27.

The upper case 35 is a hollow body having an opening 36 formed at the bottom. The upper case 35 includes a top plate portion 37, a peripheral wall portion 38, and an outer peripheral flange 39. The peripheral wall portion 38 has a looped planar shape, and the upper end of the peripheral wall portion 38 is connected to the outer peripheral edge of the top plate portion 37. The outer peripheral flange 39 has a looped planar shape, and the inner peripheral edge of the outer peripheral flange 39 is connected to the lower end of the peripheral wall portion 38.

As shown in FIG. 1, the battery module 40 is provided inside the lower case 24. The battery module 40 includes a battery stack 41, end plates 48, and restraining members (not shown).

As shown in FIG. 1, the battery stack 41 extending in the front-rear direction includes a plurality of battery cells 43 that is lithium ion batteries, and a plurality of insulating members (spacers, not shown) each positioned between adjacent battery cells 43. The battery cell 43 includes a cathode and an anode (both not shown).

The battery module 40 includes a pair of front and rear end plates 48. The front end plate 48 is positioned immediately in front of the foremost battery cell 43. The rear end plate 48 is positioned immediately behind the rearmost battery cell 43.

Both front and rear ends of the restraining members are fixed to the front and rear end plates 48, and the front-to-rear length of each restraining member is smaller than that in a free state. That is, the front and rear end plates 48 are drawn toward each other by the restraining members, whereby the front and rear end plates 48 sandwich the battery stack 41 from the front and rear. In this manner, the battery module 40 is constructed.

The battery module 40 further includes many busbars (not shown) connected to the cathode and the anode of each battery cell 43.

As shown in FIGS. 1 and 2, the panel member 50 is a flat plate member having a substantially rectangular planar shape. The panel member 50 is made of iron. As shown in FIG. 1, the upper surface of the panel member 50 is fixed to the lower surface of the lower case 24.

As shown in FIG. 3, the interior of the panel member 50 is constructed with a honeycomb structure 52. That is, many holes 53 each having a hexagonal sectional shape are formed inside the panel member 50. The "hexagon" includes a regular hexagon and a substantially regular hexagon. Each hexagonal hole 53 extends in the right-left direction. That is, each hole 53 extends across the entire width of the panel member 50 in the right-left direction.

The size of each hexagonal hole 53 gradually decreases from the bottom to the top. The right and left sides of the panel member 50 are covered by side surface portions 55. The upper surface of the panel member 50 is covered by an upper surface portion 56. The lower surface of the panel member 50 is covered by a lower surface portion 57. The front surface of the panel member 50 is covered by a front surface portion 58. The rear surface of the panel member 50 is covered by a rear surface portion 59. That is, the panel member 50 is exposed to the outside of the vehicle, but the honeycomb structure 52 is not exposed to the outside of the panel member 50.

The outer peripheral flange 39 of the upper case 35 is placed, via a sealing member (not shown), on the entire upper surface of the outer peripheral flange 28 of the lower case 24 that houses the battery module 40 and is integrated with the panel member 50, and the outer peripheral flange 28 and the outer peripheral flange 39 are fixed to each other. Thus, the battery pack 20 is completed.

As shown in FIG. 1, the battery case 22 of the completed battery pack 20 is supported by the rockers 12 and the cross members 14.

### Operations and Effects

Next, the operations and effects of the embodiment will be described.

The battery pack 20 according to the present embodiment includes the panel member 50 fixed to the lower surface of the lower case 24 (battery case 22). The panel member 50 is made of iron that has higher heat resistance than aluminum. The cross section of the panel member 50 cut along a plane orthogonal to the right-left direction (horizontal direction) is the honeycomb structure 52 having many hexagonal holes 53. The size of each hexagonal hole 53 gradually decreases from the bottom to the top. Therefore, the upper portion of the panel member 50 has higher heat resistance than the lower portion. Thus, the upper portion of the panel member 50 (with the small holes 53) suppresses the spread of flames generated around the panel member 50 to the lower surface of the battery case 22 (lower case 24).

When an object collides with the panel member 50, the lower portion of the panel member 50 can exhibit higher shock resistance than the upper portion. That is, the large holes 53 on the lower side of the panel member 50 are more likely to deform than the small holes 53 on the upper side. Therefore, for example, when a stone etc. on a road surface hits the lower surface portion 57 of the panel member 50, the large holes 53 on the lower side of the panel member 50 deform, thereby absorbing a force applied to the panel member 50 from the stone etc. more efficiently (than the small holes 53 on the upper side).

The internal structure of the panel member 50 is the honeycomb structure. Therefore, the panel member 50 can exhibit greater shock absorption properties than in the case where the holes 53 have a shape other than the hexagonal shape. Although the panel member 50 is made of iron that has a higher specific gravity than aluminum, the internal structure of the panel member 50 is the honeycomb structure (hollow structure), thereby suppressing an increase in weight of the panel member 50.

The panel member 50 provided immediately below the battery case 22 (lower case 24) of the battery pack 20 can exhibit high heat resistance and high shock resistance against a colliding object.

Although the battery pack according to the embodiment has been described above, the design can be modified as appropriate without departing from the spirit and scope of the present disclosure.

For example, the battery pack may include a plurality of battery modules.

As long as the diameter of each hole 53 in the panel member 50 gradually decreases from the bottom to the top, the sectional shape of the hole 53 need not be the hexagonal shape. For example, the internal structure of the panel member 50 may be a structure in which polyhedrons (e.g., dodecahedrons) each having a shape close to a sphere are densely placed and integrated (fixed) to each other, and the diameter of each polyhedron may gradually decrease from the bottom to the top. In this case as well, the panel member 50 can exhibit high heat resistance and high shock resistance against a colliding object.

A member different from the battery case 22 and the panel member 50 may be interposed between the lower surface of the battery case 22 (lower case 24) and the panel member 50 positioned immediately below the battery case 22.

The vehicle may be an electrified vehicle that is different from a battery electric vehicle and includes an electric motor using electric power of the battery pack 20. For example, the vehicle may be a hybrid electric vehicle or a plug-in hybrid electric vehicle.

What is claimed is:

1. A battery pack comprising:
a battery case that houses a battery module including a plurality of battery cells and is mounted on a vehicle; and
a panel member that is provided immediately below the battery case and is exposed to an outside of the vehicle, wherein
a cross section of the panel member cut along a plane orthogonal to a horizontal direction has a shape with a plurality of holes, and
a size of each of the holes gradually decreases from a bottom to a top.

2. The battery pack according to claim 1, wherein the holes are hexagonal holes.

3. The battery pack according to claim 1, wherein the panel member is made of iron.
